(19) United States
(12) Patent Application Publication
(10) Pub. No.: US 2020/0021208 A1
(43) Pub. Date: Jan. 16, 2020

(54) DC MOTOR AUTO LIFT

(71) Applicant: CHUN NIEN KING, SANTA ANA, CA (US)

(72) Inventor: CHUN NIEN KING, SANTA ANA, CA (US)

(21) Appl. No.: 16/035,529

(22) Filed: Jul. 13, 2018

(51) Int. Cl. H02P 1/18; H02M 7/219; H02K 11/20; H02K 23/66; B66F 7/00

(52) U.S. Cl. CPC H02P 1/18; H02M 7/219; B66F 7/00; H02K 23/66; H02K 11/20

(57) ABSTRACT

A DC motor drive comprises an AC to DC exchange system, a circuit protection system and a motor start system connected to a DC motor. The AC to DC exchange system is connected to an AC power supply and is configured to convert AC power to DC power. The circuit protection system is connected to the AC to DC exchange system. The circuit protection system includes a resistor connected in series with a diode. The motor start system includes a first switch and a second switch. The first switch is connected across the DC motor and the second switch connected in series with the DC motor. When the AC supply is applied to the DC motor drive of the auto lift, the AC to DC exchange system converts the AC power to DC power which starts the DC motor by means of the motor start system.

### BACKGROUND OF THE DISCLOSURE

### Technical Field of the Disclosure

This invention relates generally to portable vehicle lifts and more particularly, to an auto lift system with a DC motor to provide high starting torque.

### Description of the Related Art

A DC motor is an electrical machine that converts electrical energy into mechanical energy. A DC motor's speed can be controlled over a wide range, using either a variable supply voltage or by changing the strength of current in its field windings. The universal motor can operate on direct current but it is a lightweight motor that uses for portable power tools and appliances. Larger DC motors are mostly used in propulsion of electric vehicles, elevators, cranes and hoists, or in drives for steel rolling mills.

A DC motor is a mechanically commutated electric motor powered from direct current. The stator provides a rotating magnetic field that drives the rotating armature. The current in the rotor is switched by the commutator to keep it stationary in space. The relative angle between the stator and rotor magnetic flux is maintained with 90 degrees, which generates the maximum torque. DC motors have a rotating armature winding, in which a voltage is induced, but non-rotating armature magnetic field and a static field winding produce the main magnetic flux or permanent magnet. The different connections of the field and armature windings provide different inherent speed/torque regulation characteristics. The speed of a DC motor can be controlled by changing the voltage applied to the armature or by changing the field current. The introduction of variable resistance in the armature circuit or field circuit allowed speed control. Modern DC motors are often controlled by power electronics systems called DC drives. DC motors can operate directly from rechargeable batteries, providing the motive power for the first electric vehicles. Today, DC motors are found in applications as small as toys and disk drives, or in large sizes to operate steel rolling mills, paper machines and in auto lifts.

Compared to DC motors, AC motors characteristics are not much good. In AC hydraulic units, single-phase AC motors are used. The startup and speed performance of an AC motor is very poor. AC motors required an effective starting equipment to start its operation. For achieving its speed change, inverter equipment(s) are used in AC motors. In the case of DC motor, it is generally characterized as a continual and standard current flow. DC motors have more torque and has its ability to move the load faster. So it can be utilized in auto lifts where heavy loads are to be raised. Moreover, DC motors produce a good starting and speed regulation characteristics. DC motors use different motor connections of the field and armature winding to produce different speed and torque regulation. The torque of the DC motor is very large and maintenance cost is relatively lower than AC motor. DC motor speed can be controlled within the winding by changing the voltage applied to the DC motors armature, or by adjusting the field frame current.

Some other device called bridge rectifier is used to convert Alternating Current AC to Direct Current DC. AC to DC conversion is achieved by means of an electrical circuit that transforms alternating current (AC) input into direct current (DC) output. They are used in power electronic applications where the power input of 50 to 60 Hertz sine waves AC voltage that requires power conversion for a DC output. The major difference between AC and DC are that, In AC it is a pulsed electricity switching polarities with 50-60 times per second, whereas DC is a continuous current coming out. The polarities do not change in DC. The drawback with a AC motor is that we cannot charge with batteries.

One of the existing auto lifts provides an electronic interface control system for a pneumatic vehicle safety lift system. In this system a driver board also includes a converter board that converts a 12V DC power source to a 5V DC ready output back to the driver board. However, this pneumatic vehicle safety lift system works only on DC supply and does not work on AC power. Another automatic case loader for loading product in a trailer provides a support framework for a drive subassembly, conveyance subassembly, an industrial robot, a distance measurement sensor, and a control subassembly. However, this safety lift system includes an AC motor with double reduction gearbox and does not provide good start-up characteristics and speed regulation characteristics.

Therefore, there is a need for a DC motor drive for operating an auto lift that provides good start-up characteristics and speed regulation characteristics. Such a DC motor drive would have high starting torque and relatively cheap maintenance cost. Further, such a needed DC motor drive would realize smooth and economical speed adjustment and does not require other matching equipment such as inverter during the start of the motor. Such a DC motor drive would provide high speed regulation and maximum speed efficiency. Such a DC motor drive would provide the inherent advantages of high efficiency and the compactness of DC motors are re-integrated into efficient, compact, stable, controllable and cheap power source with the addition of switching device. Such a DC motor drive would operate the auto lift using either AC power or DC power. Further, such a DC motor drive would provide high start-up instantaneous motor speed which prevents the motor fever or overheating and thus prevents the burning of the motor. The present embodiment overcomes shortcomings in the field by accomplishing these critical objectives.

### SUMMARY OF THE DISCLOSURE

To minimize the limitations found in the existing systems and methods, and to minimize other limitations that will be apparent upon the reading of this specifications, the preferred embodiment of the present invention provides a DC motor drive for operating an auto lift.

The DC motor drive comprises an AC to DC exchange system, a circuit protection system and a motor start system. The AC to DC exchange system is connected to an AC power supply. The AC power supply can be a single phase power supply or a three phase power supply. The AC to DC exchange system is configured to convert AC power to DC power. The AC to DC exchange system is a single phase full wave bridge rectifier for the single phase DC motor drive and it is a three phase full wave bridge rectifier for the three phase DC motor drive. The circuit protection system is connected to the AC to DC exchange system. The circuit protection system includes a resistor connected in series with a diode. The motor start system is connected to a DC motor of the auto lift. The motor start system includes a first switch and a second switch. The first switch is connected across the DC motor and the second switch is connected in series with the DC motor. The second switch is used to start the DC motor. When the AC supply is applied to the DC motor drive of the auto lift, the AC to DC exchange system converts the AC power to DC power which starts the DC motor by means of the motor start system. The DC motor thus started operates the auto lift. The torque of the DC motor is relatively large and has high speed regulation efficiency to achieve smooth and economical speed adjustments. The AC to DC exchange system of the present invention provides good starting characteristics and speed regulation characteristics for the DC motor.

The method for operating the auto lift utilizing the DC motor drive comprises the steps of: providing the DC motor drive having an AC to DC exchange system, a circuit protection system and a motor start system. Then applying an AC power to the AC to DC exchange system and converting AC power to DC power by the AC to DC exchange system. The generated DC power is provided to the circuit protection system and then applied to the motor start system. The motor start system starts the DC motor and operates the auto lift.

It is a first objective of the present invention to provide for a DC motor drive for operating an auto lift that provides good start-up characteristics and speed regulation characteristics.

A second objective of the present invention is to provide a DC motor drive that has high starting torque and relatively cheap maintenance cost.

A third objective of the present invention is to provide a DC motor drive that provides smooth and economical speed adjustment and does not require other matching equipment such as inverter during the start of the motor.

A fourth objective of the present invention is to provide a DC motor drive that provides high start-up instantaneous motor speed which prevents the motor from overheating and thus prevents the burning of the motor.

Another objective of the present invention is to provide a DC motor drive that provides the inherent advantages of high efficiency and the compactness of DC motors are re-integrated into efficient, compact, stable, controllable and cheap power source with the addition of switching device.

Yet another objective of the present invention is to provide a DC motor drive that operates the auto lift using either AC power or DC power.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a block diagram of a DC motor drive for operating an auto lift in accordance with the preferred embodiment of the present invention;

FIG. 2 illustrates a circuit diagram of a single phase DC motor drive for operating the auto lift in accordance with the preferred embodiment of the present invention;

FIG. 3 illustrates a circuit diagram of a three phase DC motor drive for operating the auto lift in accordance with one embodiment of the present invention; and

FIG. 4 illustrates a flowchart of a method for operating the auto lift utilizing the DC motor drive in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term “about” means+/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of and examples for, the disclosure are described herein for illustrative purposes, various equivalent modifications are possible within the scope of the disclosure, as those skilled in the relevant art will recognize.

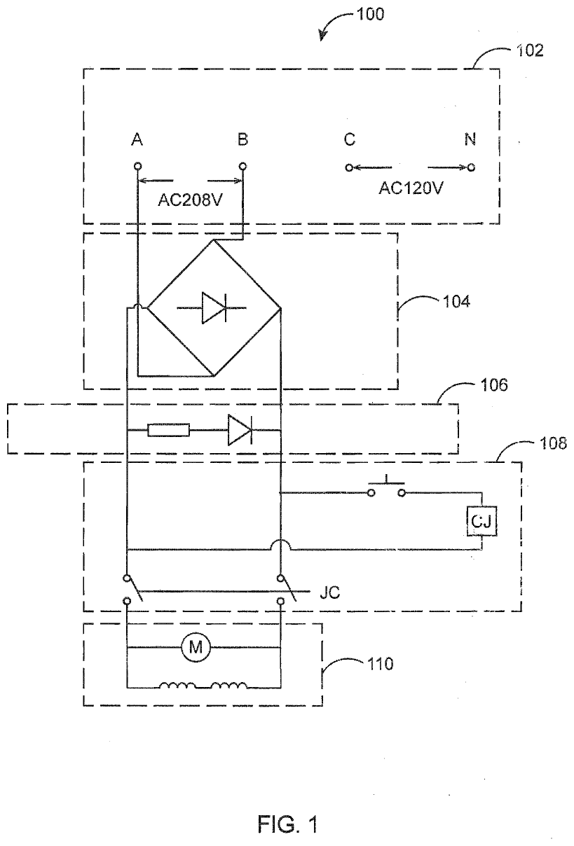

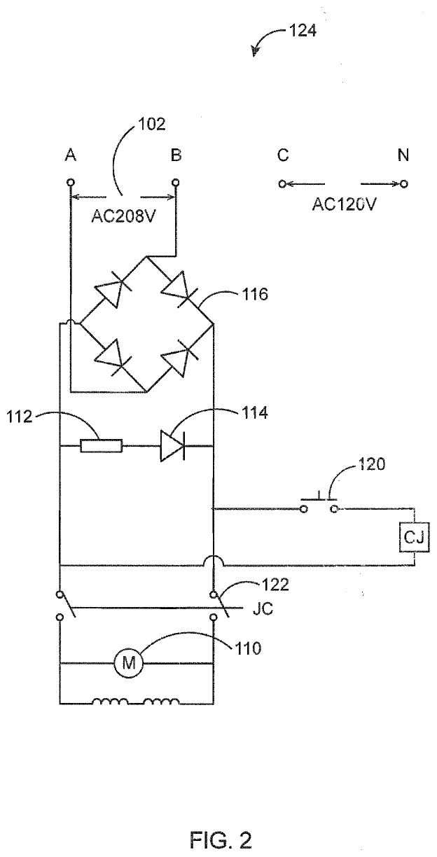

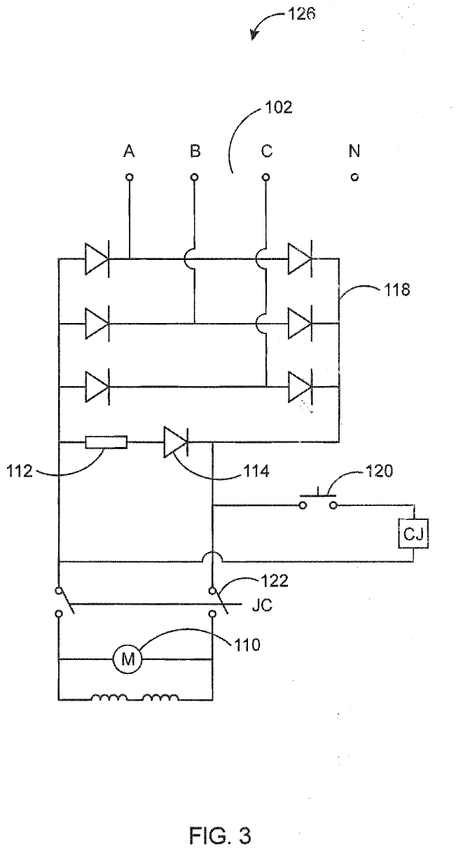

Referring to FIG. 1, a block diagram of a DC motor drive 100 for operating an auto lift in accordance with the preferred embodiment of the present invention is illustrated. The DC motor drive 100 of present invention uses an AC electrical power supply 102 which is converted to DC power internally which is used by a DC motor 110 to power the auto lift. The present invention provides immediate high torque than a conventional AC powered auto lift and has the ability to run on either AC or DC power. The DC motor drive 100 can be used as a single phase DC motor drive 124 (see FIG. 2) and a three phase DC motor drive 126 (see FIG. 3). The DC motor drive 100 comprises an AC to DC exchange system 104, a circuit protection system 106 and a motor start system 108 connected to the DC motor 110. The AC to DC exchange system 104 is connected to the AC power supply 102. The AC power supply 102 can be a single phase power supply (see FIG. 2) or a three phase power supply (see FIG. 3). The AC to DC exchange system 104 is configured to convert AC power to DC power. The circuit protection system 106 is connected to the AC to DC exchange system 104. The circuit protection system 106 includes a resistor 112 connected in series with a diode 114. The motor start system 108 is connected to the DC motor 110 of the auto lift. The motor start system 108 includes a first switch 120 and a second switch 122. The first switch 120 is connected across the DC motor 110 and the second switch 122 is connected in series with the DC motor 110.

FIGS. 2 and 3 illustrate a circuit diagram of a single phase DC motor drive 124 and a three phase DC motor drive 126 respectively for operating the auto lift. The AC to DC exchange system 104 is connected to the AC power supply 102 and is configured to convert AC power to DC power. The AC to DC exchange system 104 is a single phase full wave bridge rectifier 116 for the single phase DC motor drive 124 and it is a three phase full wave bridge rectifier 118 for the three phase DC motor drive 126. The circuit protection system 106 connected to the AC to DC exchange system 104 protects the DC motor 110 from high currents. The circuit protection system 106 includes the resistor 112 connected in series with the diode 114. The resistor 112 is a 10Ω 3 W resistor and the diode 114 is a 6 A 1 kV diode. In some embodiments, the resistor 112 can have a resistance varying from 5.1Ω to 10Ω and 10 W. In some embodiments, the diode 114 ratings can range from 6 A to 10 A and voltage ranging from 1 KV to 2 KV. The motor start system 108 is connected to the DC motor 110 of the auto lift. The motor start system 108 includes the first switch 120 and the second switch 122. The first switch 120 is connected across the is DC motor 110 and the second switch 122 is connected in series with the DC motor 110. The first switch 120 can preferably be a normally open switch and the second switch 122 is a double pole single throw switch. The second switch 122 is connected between the circuit protection system 106 and the DC motor 110. The second switch 122 is used to start the DC motor 110. When the AC supply 102 is applied to the DC motor drive 100 of the auto lift, the AC to DC exchange system 104 converts the AC power to DC power which starts the DC motor 110 by means of the motor start system 108. The DC motor 110 thus started operates the auto lift. The AC to DC exchange system 104 of the present invention provides good starting characteristics and speed regulation characteristics for the DC motor 110. The torque of the DC motor 110 is relatively large and has high speed a regulation efficiency to achieve smooth and economical speed adjustments.

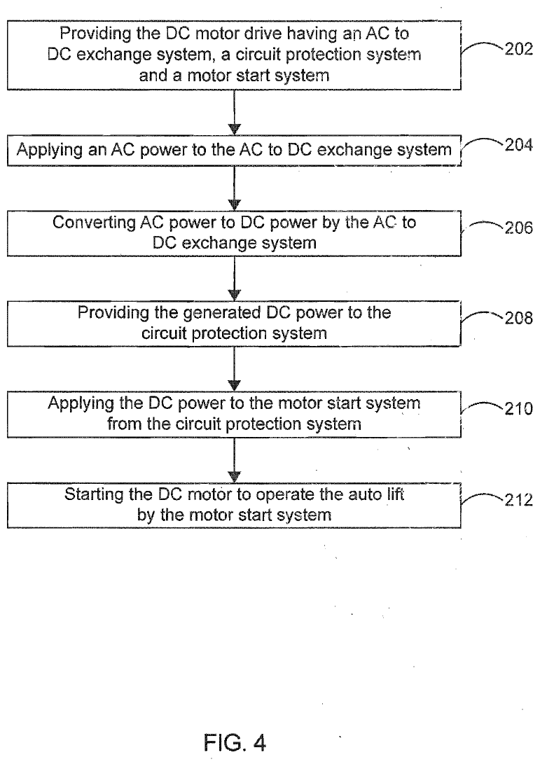

FIG. 4 illustrates a flowchart of a method for operating the auto lift utilizing the DC motor drive in accordance with the preferred embodiment of the present invention. The method comprising the steps of: providing the DC motor drive having an AC to DC exchange system, a circuit protection system and a motor start system as indicated in block 202. Applying an AC power to the AC to DC exchange system as indicated in block 204. Then converting AC power to DC power by the AC to DC exchange system as indicated in block 206. Providing the generated DC power to the circuit protection system as indicated in block 208 and applying the DC power to the motor start system from the circuit protection system as indicated in block 210. Starting the DC motor to operate the auto lift by the motor start system as indicated in block 212.

The DC motor drive 100 of the present invention uses AC electrical power 102 from the single phase or three phase supply and converts it into DC power internally in the motor 110 which is used to operate the auto lift. The DC motor drive 100 provides more immediate high torque than any conventional AC motor used in the auto lifts and has the ability to operate using either AC power or DC power. In one embodiment, additional storage unit and safety devices are provided in case of a power failure. The DC motor drive 100 is primarily used in auto lifts. The present DC motor drive 100 can also be utilized in aircraft hangar door lifts and similar applications.

The DC motor drive 100 of the present invention provides good starting characteristics and speed regulation characteristics. The torque of the DC motor is relatively large which enables smooth and economical speed adjustment of the motor 110 to operate the auto lift, and does not require any additional starting equipment to start the as motor 110. Thus the present invention replaces the AC current motor used in auto repair lifts with the DC motor 110 which has more torque and has the ability to move the load faster. The DC motor drive 100 is more energy-saving and environmentally friendly and maintenance is relatively cheap. With the addition of switching devices such as the first switch 120 and the second switch 122, the inherent advantages of high efficiency and compactness of the DC motor 110 is re-integrated into efficient, compact, stable, controllable and cheap power source.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A DC motor drive for an auto lift, comprising:
an AC to DC exchange system connected to an AC power supply and configured to convert AC power to DC power,
a circuit protection system having a resistor connected in series with a diode; and
a motor start system connected to a DC motor of the auto lift, the motor start system having a first switch and a second switch;
whereby the AC to DC exchange system converts the AC power to DC power which starts the DC motor by means of the motor start system and enables the DC motor to operate the auto lift.

2. The DC motor drive of claim 1 wherein the AC power supply is a single phase power supply.

3. The DC motor drive of claim 1 wherein the AC power supply is a three phase power supply.

4. The DC motor drive of claim 1 wherein the AC to DC exchange system is a single phase full wave bridge rectifier.

5. The DC motor drive of claim 1 wherein the AC to DC exchange system is a three phase full wave bridge rectifier.

6. The DC motor drive of claim 1 wherein the circuit protection system protects the DC motor from high currents.

7. The DC motor drive of claim 1 wherein the resistor is a 10Ω 3 W resistor.

8. The DC motor drive of claim 1 wherein the diode is a 6 A 1 kV diode.

9. The DC motor drive of claim 1 wherein the first switch is connected across the DC motor and the second switch is connected in series with the DC motor.

10. The DC motor drive of claim 1 wherein the first switch is a normally open switch.

11. The DC motor drive of claim 1 wherein the second switch is a double pole single throw switch.

12. The DC motor drive of claim 1 wherein the second switch is connected between the circuit protection system and the DC motor.

13. The DC motor drive of claim 1 wherein the second switch is used to start the DC motor.

14. The DC motor drive of claim 1 wherein the AC to DC exchange system provides good starting characteristics and speed regulation characteristics for the DC motor.

15. The DC motor drive of claim 1 wherein the torque of the DC motor is relatively large and has high speed regulation efficiency to achieve smooth and economical speed adjustments.

16. A DC motor drive for an auto lift, comprising:
an AC to DC exchange system connected to an AC power supply, the AC to DC exchange system configured to convert AC power to DC power,
a circuit protection system connected to the AC to DC exchange system, the circuit protection system having a resistor connected in series with a diode; and
a motor start system connected to a DC motor of the auto lift, the motor start system having a first switch and a second switch, the first switch connected across the DC motor and the second switch connected in series with the DC motor;
whereby the AC to DC exchange system converts the AC power to DC power which starts the DC motor by means of the motor start system and enables the DC motor to operate the auto lift.

17. The DC motor drive of claim 16 wherein the AC power supply is a single phase power supply.

18. The DC motor drive of claim 16 wherein the AC power supply, is a three phase power supply.

19. The DC motor drive of claim 16 wherein the AC to DC exchange system is a single phase full wave bridge rectifier.

20. The DC motor drive of claim 16 wherein the AC to DC exchange system is a three phase full wave bridge rectifier.

21. The DC motor drive of claim 16 wherein the circuit protection system protects the DC motor from high currents.

22. The DC motor drive of claim 16 wherein the resistor is a 10Ω 3 W resistor.

23. The DC motor drive of claim 16 wherein the diode is a 6 A 1 kV diode.

24. The DC motor drive of claim 16 wherein the first switch is a normally open switch.

25. The DC motor drive of claim 16 wherein the second switch is a double pole single throw switch.

26. The DC motor drive of claim 16 wherein the second switch is connected between the circuit protection system and the DC motor.

27. The DC motor drive of claim 16 wherein the second switch is used to start the DC motor.

28. The DC motor drive of claim 16 wherein the AC to DC exchange system provides good starting characteristics and speed regulation characteristics for the DC motor.

29. The DC motor drive of claim 16 wherein the torque of the DC motor is relatively large and has high speed regulation efficiency to achieve smooth and economical speed adjustments.

30. A method for operating an auto lift utilizing a DC motor drive, the method comprising the steps of:
a) providing the DC motor drive having an AC to DC exchange system, a circuit protection system and a motor start system;
b) applying an AC power to the AC to DC exchange system;
c) converting AC power to DC power by the AC to DC exchange system;
d) providing the generated DC power to the circuit protection system;
e) applying the DC power to the motor start system from the circuit protection system; and
f) starting the DC motor to operate the auto lift by the motor start system.
